(19) United States
(12) Patent Application Publication
(10) Pub. No.: US 2007/0223462 A1
(43) Pub. Date: Sep. 27, 2007

(54) Enhanced service delivery platform that provides a common framework for use by IMS and Web applications in delivering services

(76) Inventors: Steven Hite, Marietta, GA (US); Abdi Modarressi, Lawrenceville, GA (US); Lou Topfl, Atlanta, GA (US); Ron Iannetta, Travelers Rest, SC (US); John R. Wright, Helena, AL (US); David Castro, Suwanee, GA (US); Michael S. Denny, Sharpsburgh, GA (US)

Correspondence Address: MYERS BIGEL SIBLEY & SAJOVEC, P.A., P.O. BOX 37428, RALEIGH, NC, 27627, US

(21) Appl. No.: 11/505,589

(22) Filed: Aug. 17, 2006

Related U.S. Application Data
(60) Provisional application No. 60/786,194, filed on Mar. 27, 2006.
(60) Provisional application No. 60/786,479, filed on Mar. 28, 2006.

(51) Int. Cl. H04L 12/66

(52) U.S. Cl. 370/356

(57) ABSTRACT

A system for supporting Internet protocol (IP) multimedia subsystem (IMS) applications, Web based applications, and converged IMS/Web based applications that use a service delivery network includes an application services middle layer between the applications and the service delivery network that includes a plurality of common components that are usable by the different applications to provide services over the service delivery network.

### RELATED APPLICATIONS

This application claims the benefit of and priority to U.S. Provisional Patent Application No. 60/786,194, filed Mar. 27, 2006, and U.S. Provisional Patent Application No. 60/786,479, filed Mar. 28, 2006, the disclosures of which are hereby incorporated herein by reference as if set forth in their entireties.

### BACKGROUND OF THE INVENTION

The present invention relates generally to communication network and, more particularly, to delivering services via communication networks.

One evolution in the development of communication networks has been the shift from circuit switching to packet switching in the core network. A circuit-switched approach is based on using a dedicated circuit between a caller and a recipient of a call. One drawback to this approach is that certain network resources associated with the circuit path may be unavailable to anyone else for the duration of the call. In contrast, packet-switching technology operates by splitting the communication traffic into information units called packets, which are transmitted over a common circuit before being organized and re-assembled at their destinations. The packets may carry voice or data information. This sharing of resources and the ability to use common network protocols may lead to a more cost-effective transmission system for network operators. Moreover, because more efficient routing techniques are generally used in packet-switched networks, information may be transmitted at higher speeds than may be possible in circuit-switched networks. The higher data speeds may support multiple services in a single session, such as voice, text, graphics, and/or video thereby supporting multi-media applications.

The Internet protocol (IP) multimedia subsystem (IMS) is a standard that has been developed to define the control and integration of multimedia services in a core, packet-switched network. In particular, the IMS architecture defines a set of logical functions that use a signaling protocol known as the session initiation protocol (SIP). SIP is used to establish communication sessions in an IP network. For example, a session may be a one-to-one voice call or a session may be more complex, such as one-to-many conference calls involving multimedia services. SIP may also be used to facilitate voice over IP (VoIP) services, in which voice is transported in IP data packets that are re-assembled and converted into an audio signal for the recipient. By using VoIP, network operators may use the same IP infrastructure to carry voice traffic that is used to carry data traffic. Thus, IMS may be summarized as a standardized way to connect IP devices and networks using SIP.

While the IMS architecture uses the SIP protocol to establish communication sessions, Web services offered on what may be called a Service Delivery Platform (SDP) use different protocols to establish communication sessions and support transactions. For example, a Web service may be described generally as a software system that is designed to support machine-to-machine interaction over a network. The interface may be described in a format such as the Web Services Description Language (WSDL), which is an Extensible Markup Language (XML) based service description on how to communicate using the Web service. Other systems may communicate with the Web service in a manner described by its WSDL interface using messages that may be enclosed in a SOAP envelope. SOAP is a protocol for exchanging XML messages over a network typically using the Hypertext Transfer Protocol (HTTP). Software applications written in various programming languages and running on various platforms may use Web services via a SDP to exchange information over a network, such as the Internet.

Unfortunately, services created for an IMS environment may not necessarily work or work as efficiently in an SDP environment that supports Web services, and services created for an SDP environment may not necessarily work or work as efficiently in an IMS environment.

### SUMMARY

According to some embodiments of the present invention, a system for supporting Internet protocol (IP) multimedia subsystem (IMS) applications, Web based applications, and converged IMS/Web based applications that use a service delivery network includes an application services middle layer between the applications and the service delivery network that includes a plurality of common components that are usable by the different applications to provide services over the service delivery network.

In other embodiments, the different applications include both third party applications and network service provider applications.

In still other embodiments, at least one of the common components provides a service to at least one application in support of the application's interaction with one or more end users.

In still other embodiments, the plurality of common components includes a unified directory component that is configured to store and manage an applications services middle layer information model.

In still other embodiments, the unified directory component includes an identity management sub-component that is configured to support the creation and management of digital identities used for user authentication and assignment of rights and privileges to individuals within a subscription, a profile management sub-component that is configured to allow access to and manage common user data within the information model, a subscription management sub-component that is configured to provide access to and to manage subscriber information within the information model, a services support sub-component that is configured to manage and provide access to information about service providers, service features, service availability, and/or service metadata, a security support sub-component that is configured to create and maintain user and device authentication, integrity, and/or ciphering data, a session management support sub-component that is configured to support call and/or session establishment procedures, and a policy support sub-component that is configured to provide rules governing the user and delivery of the services.

In still other embodiments, the plurality of common components includes a content services component that is configured to control content acquisition and delivery of the content to subscribers of content services.

In still other embodiments, the content services component includes a content management sub-component that is configured to manage the life cycle of content objects, and a digital rights management sub-component that is configured to control consumption of digital media objects by allowing content providers to express usage rights.

In still other embodiments, the plurality of common components includes a session management component that is configured to manage the orchestration, interaction, and delivery of the services during a subscribed session.

In still other embodiments, the session management component includes a converged services management sub-component that is configured to manage an integration session context comprising a plurality of service types, a mobility management sub-component that is configured to enable roaming for an end user by providing hand-off of applications that are in progress, and a service policy management component that is configured to determine service characteristics based on defined rules.

In still other embodiments, the plurality of common components includes a location services component that is configured to aggregate information about a physical/geographic location of a user, device, network, and/or network entity.

In still other embodiments, the plurality of common components includes a notification services component that is configured to send notices to users and/or devices on demand, at a defined time, and/or on a scheduled basis.

In still other embodiments, the plurality of common components includes a presence services component that is configured to aggregate user and/or device availability information across applications, devices, and/or networks.

In still other embodiments, the plurality of common components includes a security component that is configured to manage security associated with delivery of the services.

In still other embodiments, the security component includes an authentication/authorization sub-component that is configured to authenticate users and to authorize the users to invoke the applications and/or the services, a single sign on sub-component that is configured to enable users to be authenticated across multiple services and/or applications, and a security policy management sub-component that is configured to manage policies and/or rules associated with user and/or device authentication and/or authorization.

In still other embodiments, the plurality of common components includes a service creation component that is configured to support the definition, creation, and/or registering of the services.

In still other embodiments, the service creation component includes a service definition/packaging sub-component that is configured to define and/or package the services for presentation and consumption.

In still other embodiments, the plurality of common components includes a service provisioning component that is configured to create an instance of a registered service for a particular subscriber.

In still other embodiments, wherein the service provisioning component includes a provisioning request management sub-component that is configured to create a service instance based on a service catalog.

In still other embodiments, the plurality of common components includes a performance management component that is configured to ensure that the services are delivered according to a particular quality of service (QoS).

In still other embodiments, the performance management component includes a QoS event collection sub-component that is configured to detect and collect information on QoS violations, and a resource management sub-component that is configured to manage resources used to deliver the services.

In still other embodiments, the plurality of common components includes a partner management component that is configured to manage the access of third parties to the applications, services, and/or common components.

In still other embodiments, the partner management component includes a partner services sub-component that is configured to control and/or audit access to the applications, services, and/or common components, and a third party interface sub-component that is configured to provide binding of third party applications to the applications and/or common components.

In still other embodiments, the plurality of common components includes a usage data collection component that is configured to collect and aggregate information on usage of the services.

In still other embodiments, the usage data collection component includes a usage/events collection sub-component that is configured to capture user and/or network events.

In still other embodiments, the plurality of common components includes a gateways component that is configured to provide access to services on other networks and/or to subscriber devices.

In still other embodiments, the gateways component includes a circuit switched access sub-component that is configured to provide connectivity to public switched telephone network (PSTN) services, an advanced intelligent network (AIN) access sub-component that is configured to provide connectivity to PSTN signaling system seven (SS7) services, and a devices services sub-component that is configured to allow the subscriber devices to access the applications and/or services.

In further embodiments, a computer program product includes a computer readable medium having computer readable program code embodied therein. The computer readable program code includes computer readable program code configured to provide the application services middle layer.

In other embodiments, a method of providing services for an application middle layer between Internet protocol (IP) multimedia subsystem (IMS) applications, Web based applications, and converged IMS/Web based applications and a service delivery network, includes determining common services used by the different applications, abstracting the common services to provide a common interface to the services to the different applications, and incorporating the abstracted common services into the application middle layer as a plurality of common components.

In still other embodiments, the different applications comprise both third party applications and network service provider applications.

In further embodiments, a method of delivering services over a service delivery network includes providing an application services middle layer between Internet protocol (IP) multimedia subsystem (IMS) applications, Web based applications, and converged IMS/Web based applications and the service delivery network that includes a plurality of common components, and making use of the plurality of common components by the different applications to provide services via the service delivery network.

In still further embodiments, the different applications comprise both third party applications and network service provider applications.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a Internet protocol (IP) multimedia subsystem (IMS) network in accordance with some embodiments of the present invention;

FIGS. 2A and 2B are diagrams that illustrate the evolution of IMS based service delivery systems and Web based service delivery systems, respectively;

FIG. 3 is a diagram that illustrates an enhanced Service Delivery Platform (eSDP) in accordance with some embodiments of the present invention;

FIG. 4 is a diagram that illustrates the eSDP of FIG. 3 in greater detail in accordance with some embodiments of the present invention;

FIGS. 5A-5M illustrate various components of the eSDP in accordance with some embodiments of the present invention; and

FIGS. 6 and 7 are flowcharts that illustrate operations for determining what services are provided by the components comprising the eSDP and providing services over a service delivery network, respectively, in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “IP terminal or device” refers to a terminal or device that may communicate using the session initiation protocol (SIP). It will be understood that an IP terminal or device may also refer to devices that communicate using SIP via a media gateway, which translates communications, for example, between an IP network and another network, such as the public switched telephone network or a circuit switched wireless network.

As used herein, the term “packet” means a unit of information and/or a block of data that may be transmitted electronically as a whole or via segments from one device to another. Accordingly, as used herein, the term “packet” may encompass such terms of art as “frame” and/or “message,” which may also be used to refer to a unit of transmission.

Some embodiments of the present invention stem from a realization that there are various functional capabilities that are provided by both an Internet protocol (IP) multimedia subsystem (IMS) network based on the Session Initiation Protocol (SIP) and a Service Delivery Platform (SDP) that supports Web services. These common functional capabilities may be aggregated to provide a middle layer between the services and a connectivity network, such as an Internet Protocol (IP) connectivity network. The aggregated functional capabilities may be used to comprise an enhanced Service Delivery Platform (eSDP) that provides a unified infrastructure over which service providers may offer SIP services, Web services, and/or services that use aspects of both SIP and Web protocols.

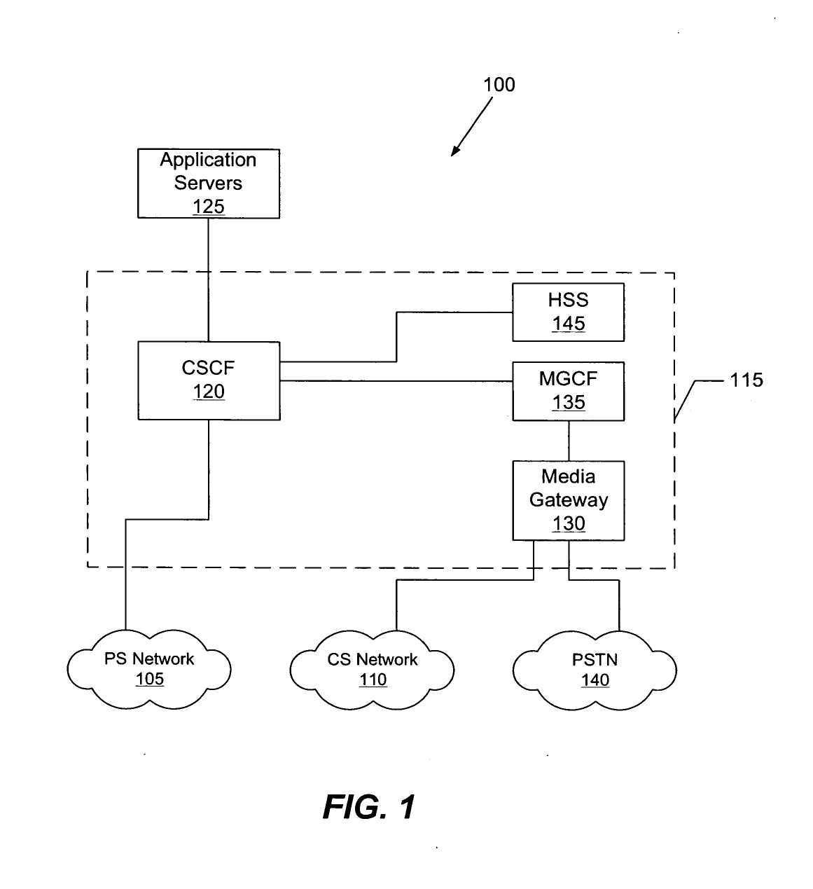

Referring to FIG. 1, an IMS communication network 100 that uses SIP, in accordance with some embodiments of the present invention, comprises communication networks 105 and 110, which are coupled to an IMS network 115 as shown. The network 105 may be a packet-switched network that serves one or more IP terminals/devices. The network 110 may be a circuit-switched network that provides communication facilities for one or more mobile terminals. In accordance with various embodiments of the present invention, the IP terminal providing content to one or more other IP terminals or devices may be connected to either the packet-switched network 105 or the circuit-switched network 110. Likewise, an IP terminal that receives content from an IP terminal or device may be connected to either the packet-switched network 105 or the circuit-switched network 110.

The network 105 connects to the IMS network 115 via the call session control function (CSCF) 120. The CSCF 120 is connected to one or more application servers 125 and enables the registration of IP terminals/devices and the routing of session initiation protocol (SIP) signaling messages between the application servers 125 and the IP terminals/devices. The CSCF 120 may provide similar functionality for the terminals/devices connected serviced by the network 110 via a media gateway 130 and media gateway control function (MGCF) 135. The MGCF 135 enables SIP signaling to inter-work with other types of signaling used by the media gateway 130. Thus, the combination of the MGCF 135 and the media gateway 130 may provide an interface between the SIP signaling used in the IMS network 115 and the signaling used in the network 110 and/or the public switched telephone network (PSTN) 140.

The communication network 100 may further comprise a home subscriber server (HSS) database 145 that maintains a service profile and other information for each end-user and associated IP terminal/device that has registered with the IMS network 115. The profile and other information may include, but is not limited to, IP address information, roaming information, and/or telephony services information. Moreover, as will be described in more detail hereafter, the HSS may store information regarding whether an IP terminal/device has registered as a content provider for other, subscribing, IP terminals/devices and whether a subscribing IP terminal/device should be alerted when a particular content providing IP terminal/device has registered to indicate that it has content available for transmission.

The various elements of the communication network 100 may be connected by a global network, such as the Internet or other publicly accessible network. Various elements of the network may be interconnected by a wide area network, a local area network, an Intranet, and/or other private network, which may not accessible by the general public. Thus, the communication network 100 may represent a combination of public and private networks or a virtual private network (VPN). Although FIG. 1 illustrates an exemplary communication network, it will be understood that the present invention is not limited to such configurations, but is intended to encompass any configuration capable of carrying out the operations described herein.

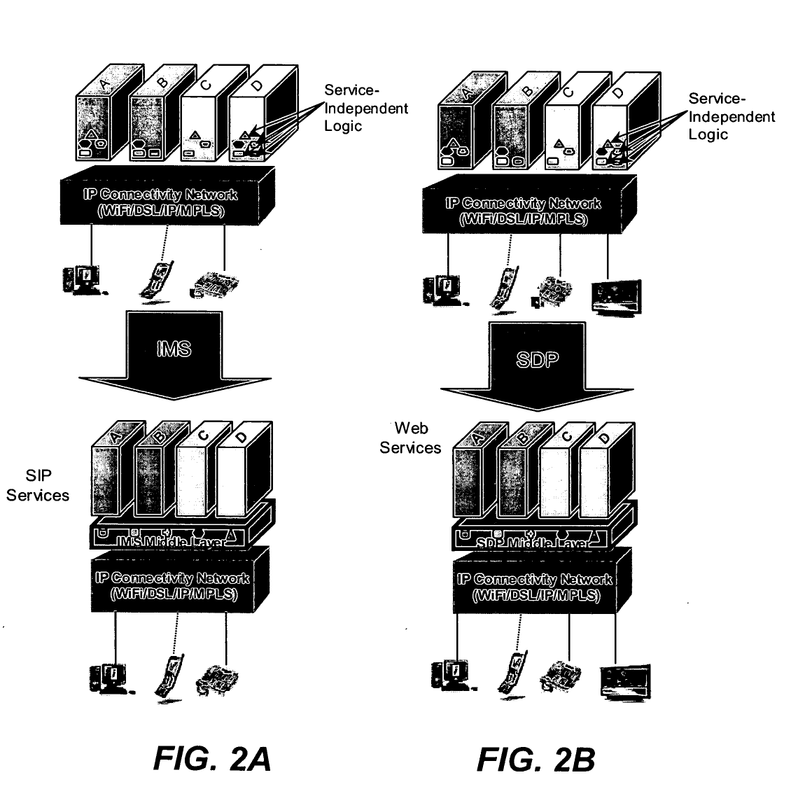

FIGS. 2A and 2B are diagrams that illustrate the evolution of IMS/SIP based service delivery systems and SDP/Web based service delivery systems, respectively. As shown in FIGS. 2A and 2B, service independent logic from stand-alone SIP services and Web services can be pulled out to provide an IMS middle layer and an SDP middle layer, respectively, that act as interfaces between the services and the connectivity network. The IMS and SDP middle layers may provide common reusable capabilities so as to avoid having to develop such functional capabilities repeatedly for each application.

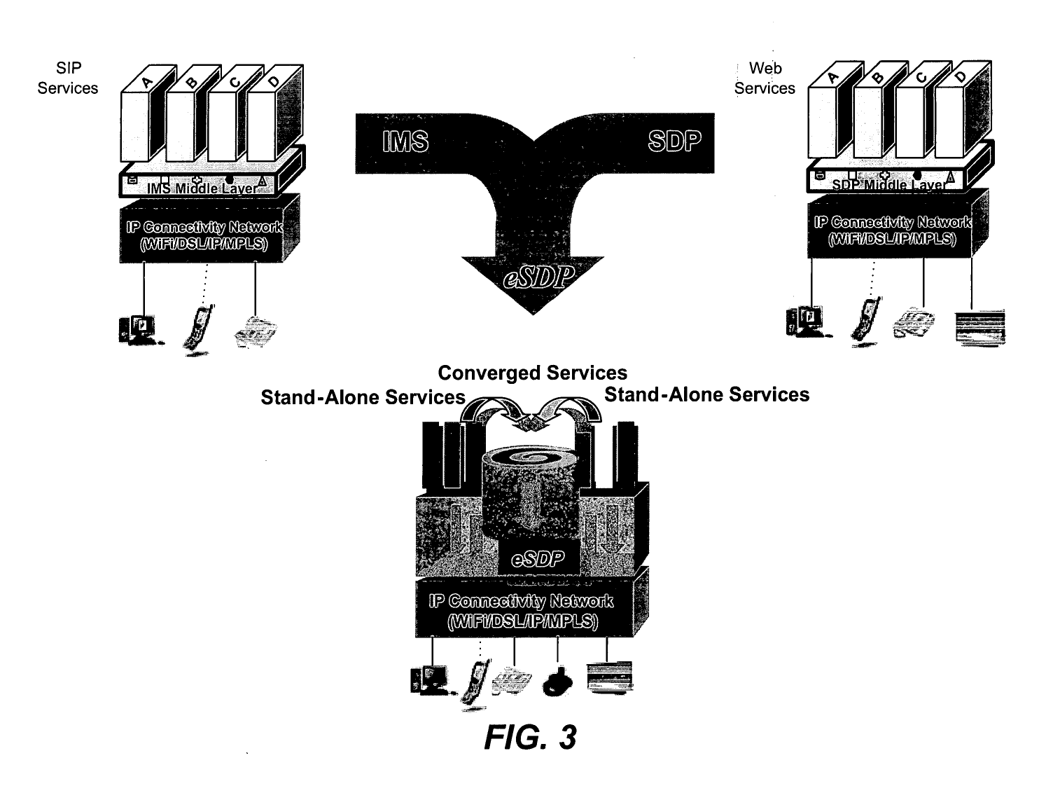

Referring now to FIG. 3, an enhanced Service Delivery Platform (eSDP) can be created, in accordance with some embodiments of the present invention, by aggregating the IMS middle layer and the SDP middle layer to provide a plurality of common capabilities that support both IMS/SIP stand-alone services, SDP/Web stand-alone services, and services that use aspects of both IMS and SDP/Web capabilities. The eSDP provides an interface between IMS/SIP and SDP/Web services and a connectivity network, such as an IP connectivity network. Advantageously, the eSDP may result in lower costs per service because service providers need not develop certain functionality repeatedly for each application, but instead can make use of functionality and capabilities provided by the eSDP that are shared across applications, both IMS/SIP and SDP/Web. Moreover, the eSDP may provide users with a seamless experience when transitioning between IMS/SIP and SDP/Web services. For example, a user may starts a SIP voice application and then decide to access a Web based location service. The eSDP may provide a single authentication function that is valid for both the SIP service and the Web service so that the user does not have to execute an authentication procedure for each service.

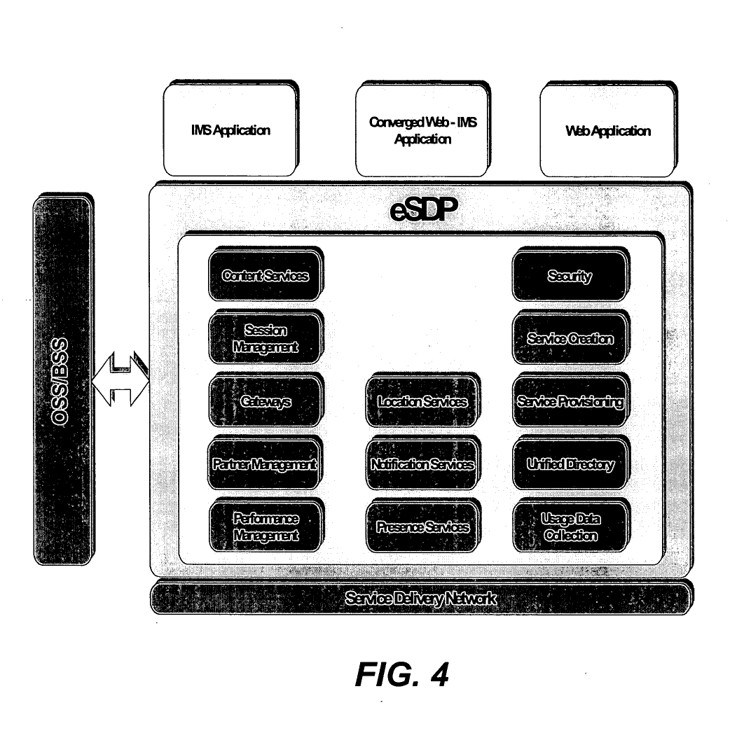

FIG. 4 is a block diagram that illustrates the eSDP in more detail in accordance with some embodiments of the present invention. As discussed above, the eSDP provides an interface between an IMS/SIP application, an SDP/Web application, a converged Web-IMS application (i.e., an application that uses both IMS/SIP and SDP/Web functionality) and a service delivery network, such as an IP connectivity network. It will be understood, however, that the service delivery network may use any transport mechanism in accordance with various embodiments of the present invention. The eSDP may wrap services into a single cohesive framework, which may reduce complexity, simplify interaction, and improve service management in accordance with various embodiments of the present invention. A network Operations Support System (OSS) may be used to manage and maintain the eSDP. In accordance with various embodiments of the present invention, the eSDP may comprise a plurality of functional modules or components as shown in FIG. 4. These functional modules/components may include, but are not limited to, a content services component, a session management component, a gateways component, a partner management component, a performance management component, a location services component, a notification services component, a presence services component, a security component, a service creation component, a service provisioning component, a unified directory component, and a usage data collection component. It will be understood that, in accordance with various embodiments of the present invention, an eSDP may include additional or fewer modules/components than those shown in FIG. 4 depending on the IMS/SIP, SDP/Web, and/or converged Web-IMS applications to be supported.

The functionality of the eSDP of FIGS. 3 and 4 may be implemented as a single processor system, a multi-processor system, or even a network of stand-alone computer systems, in accordance with various embodiments of the present invention.

Computer program code for carrying out operations of an eSDP discussed above with respect to FIGS. 3 and 4 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. In some embodiments, the computer program code may include commercially available applications and/or components provided by third parties. It will be further appreciated that the functionality of any or all of the program modules may also be implemented using discrete hardware components, one or more application specific integrated circuits (ASICs), or a programmed digital signal processor or microcontroller.

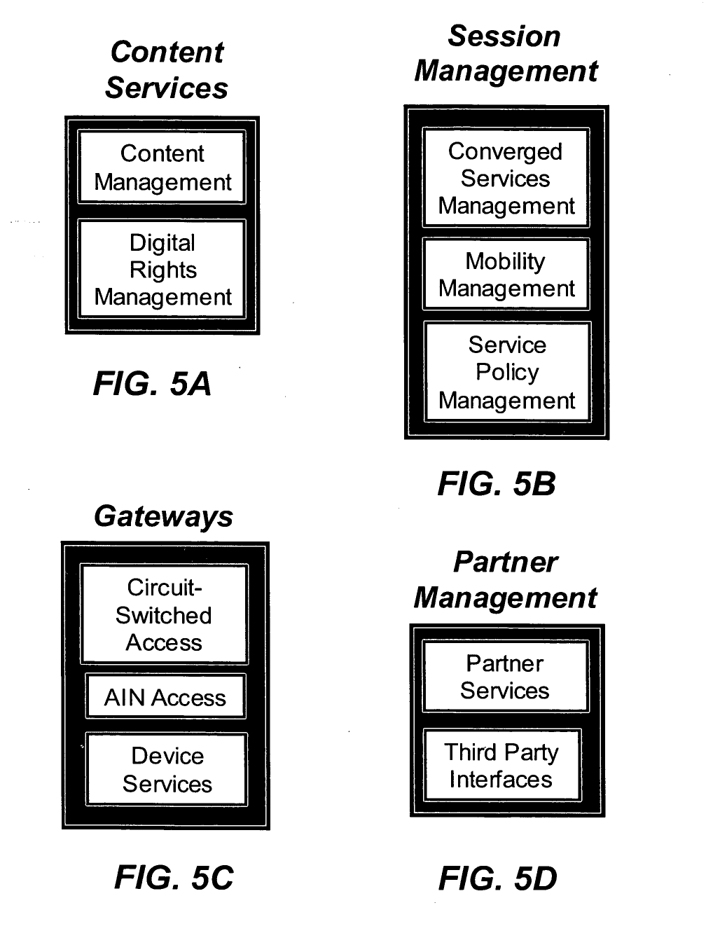

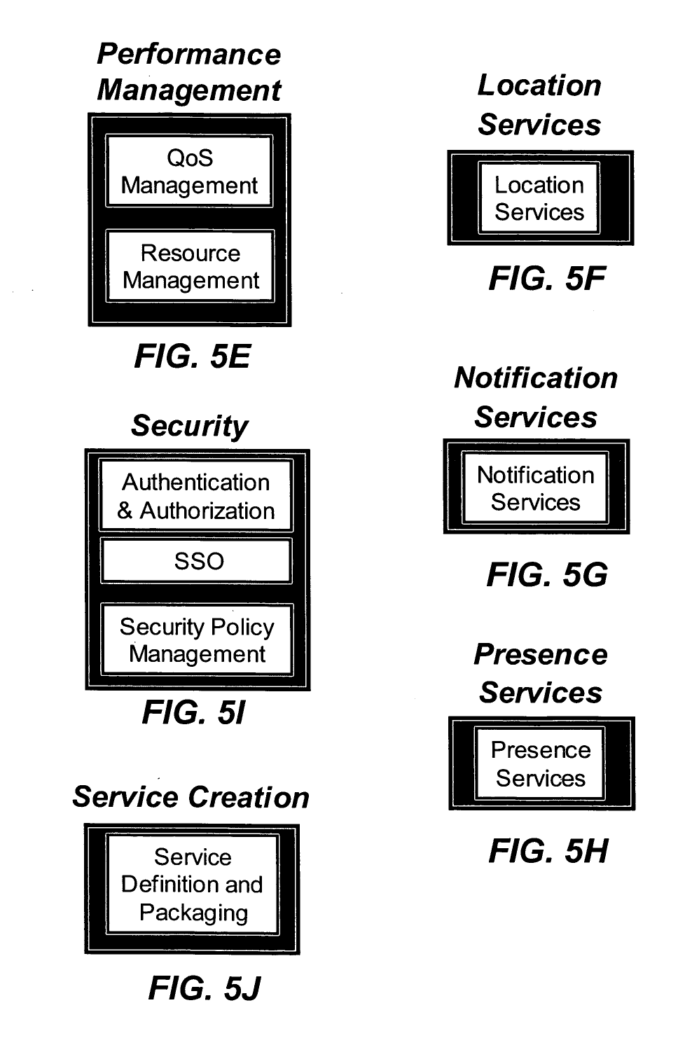

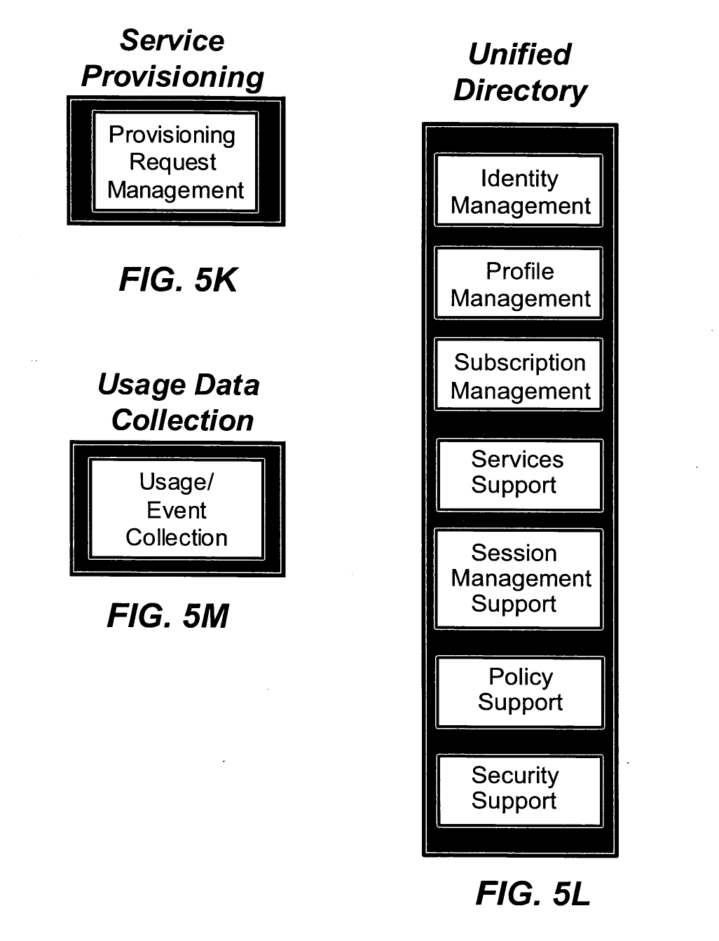

The respective components of the eSDP of FIG. 4 will now be described in greater detail with respect to FIGS. 5A through 5M. Referring to FIG. 5A, the content services component may be configured to control all aspects of content acquisition, from both third party applications and network service provider applications, and delivery of that content to subscribers of content services. The content services component may include the following two sub-components: A content management sub-component may be configured to manage the complete life cycle of local content objects. The content management sub-component may include functions for discovery, ingestion, delivery, and publication of content. A digital rights management sub-component may be configured to enable the controlled consumption of digital media objects by allowing content providers to express usage rights.

Referring to FIG. 5B, the session management component may be configured to manage the orchestration, interaction, and delivery of services during a subscribed session. The session management component may include the following three sub-components: A converged services management sub-component may be configured to orchestrate and manage an integrated session context composed of either Web services, SIP/IMS services, or both types of services. It may be used by applications to request resources, set-up and initialize the context, invite others, etc. In the context of Web services management, a Web services session context composed of complex, multi-party, multi-media services may be managed. In the context of SIP/IMS services management, the SIP call/session context may be managed. A mobility management sub-component may be configured to enable roaming of the end user and seamless hand-off of applications that have been invoked and are currently in progress. For example, a session in which a user access an address book may be maintained as the user moves from a home WIFI network to a GSM network using a dial mode handset. A service policy management sub-component may be configured to query policy/rules in the unified directory to determine service characteristics based on these rules. For example, a determination may be made whether the requested content can be consumed by the requesting device.

Referring to FIG. 5C, the gateways component may be configured to provide access to services on other networks and to subscriber devices. The gateways component may include the following three sub-components: A circuit-switched access sub-component may be configured to provide an access gateway for connectivity to PSTN services. An AIN access sub-component may be configured to provide connectivity to the PSTN SS7 network services. A device services sub-component may be configured to allow devices to access eSDP capabilities and functionality. For example, a subscriber's PDA may be used to access a unified address book.

Referring to FIG. 5D, the partner management component may be configured to manage the access of third parties to the network service provider eSDP environment. The partner management component may include the following two sub-components: A partner services sub-component may be configured to provide for controlled and audited access to the eSDP. For example, an Internet portal organization may be provided with the ability to access the unified directory services. A third party interfaces sub-component may be configured to allow the binding of third party applications to the eSDP as required.

Referring to FIG. 5E, the performance management component may be configured to ensure that services are being delivered according to the Quality of Service (QoS) that has been committed to. The performance management component may include the following two sub-components: A QoS management sub-component that may be configured to detect QoS violations and to collect data thereon. For example, metrics may be provided regarding the session performance of a third party service provider. A resource management sub-component may be configured to manage the resources required to deliver services, such as dynamically managing the inventory of server capacity and bandwidth availability. For example, the number of sessions available for a given server may be provided.

Referring to FIG. 5F, the location services component may be configured to aggregate information about the physical/geographical location of the user/device as well as the network or network entity that is currently serving, or capable of serving, the user's device. Raw data may be obtained using feeds from various networks, such as, for example, cellular, WIFI, and/or GPS infrastructures.

Referring to FIG. 5G, the notification services component may be configured to provide a mechanism for applications to send notices to users and/or devices on demand, at a specific future time and/or on a scheduled basis. The delivery of notifications may be managed along with the queuing, aging, and/or holding of notifications in accordance with various embodiments of the present invention.

Referring to FIG. 5H, the presence services component may be configured to aggregate user and device availability information across applications, devices, and/or networks. For example, a subscriber may use presence services to see active buddies while watching television.

Referring to FIG. 5I, the security component may be configured to manage security associated with the delivery of services. The security component may include the following three sub-components: An authentication and authorization sub-component that may be configured to authenticate users and devices as well as authorize them to invoke a set of applications and/or services in a secure manner. These applications include IMS applications, Web-based applications, and converged IMS/Web-based applications. A single-sign-on (SSO) sub-component that may be configured to enable users to be authenticated by other domains or Web sites without having to maintain multiple user name/password combinations. For example, a user may use a single PIN once to access multiple services without needing additional authentication. A security policy management sub-component may be configured to manage policy/rules regarding user and device authentication and authorization. For example, a user password may expire after six weeks.

Referring to FIG. 5J, the service creation component may be configured to support the definition, creation, and/or registering of services. The service creation component may include a service definition and packaging component that is configured to allow services to be defined and packaged for presentation and consumption.

Referring to FIG. 5K, a service provisioning component may be configured to create an instance of a registered service for a particular subscriber. The service provisioning component may include a provisioning request management sub-component that is configured to create a service instance based on the service catalog. This may include orchestration, configuration, and/or provisioning of the service as well as status reporting to external systems. For example, a new VoIP service may be established for an existing customer.

Referring to FIG. 5L, a unified directory component may be configured to store and manage the eSDP information model, including an HSS. The unified directory component may provide a data management repository for services and subscribers. The unified directory component may include the following seven sub-components: An identity management sub-component may be configured to support the creation and management of digital identities that are used for user authentication and assignment of rights and privileges to individuals within a subscription. For example, a subscriber may establish services permissions for different family members. A profile management sub-component may be configured to allow access to and manage common user data within the repository related to user preferences, subscriptions and/or devices. For example, a user may establish preferences for “find me, follow me.” A subscription management sub-component may be configured to provide access to and to manage subscriber information within the repository. Subscription inventory may allow for device specific service feature consumption. For example, authorization may be provided for a personalized caller-id feature. A services support sub-component may be configured to manage and provide access to information about service providers, service features, service availability, and/or service metadata. For example, a technical service description may be provided via a service catalog. A session management support sub-component may be configured to support call and/or session establishment procedures and to provide information on which a session control entity currently hosts the user. For example, information may be provided on the CSCF assigned during session creation. A policy support sub-component may be configured to provide rules governing the use and delivery of services. For example, a G.711 audio codec may be required for delivery of VoIP services. A security support sub-component may be configured to create and maintain user and device authentication, integrity, and/or ciphering data. For example, a User ID and/or password may be created and maintained.

Referring to FIG. 5M, the usage data collection component may be configured to collect and aggregate all usage of subscribed services and to send that data to relevant network operators. The usage data collection component may include a usage/events collection sub-component that is configured to capture user and network events. For example, charging information may be captured from video on demand usage.

The present invention is described hereinafter with reference to flowchart and/or block diagram illustrations of methods, mobile terminals, electronic devices, alarm systems, and/or computer program products in accordance with some embodiments of the invention.

These flowchart and/or block diagrams further illustrate exemplary operations of operating an eSDP system in accordance with various embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

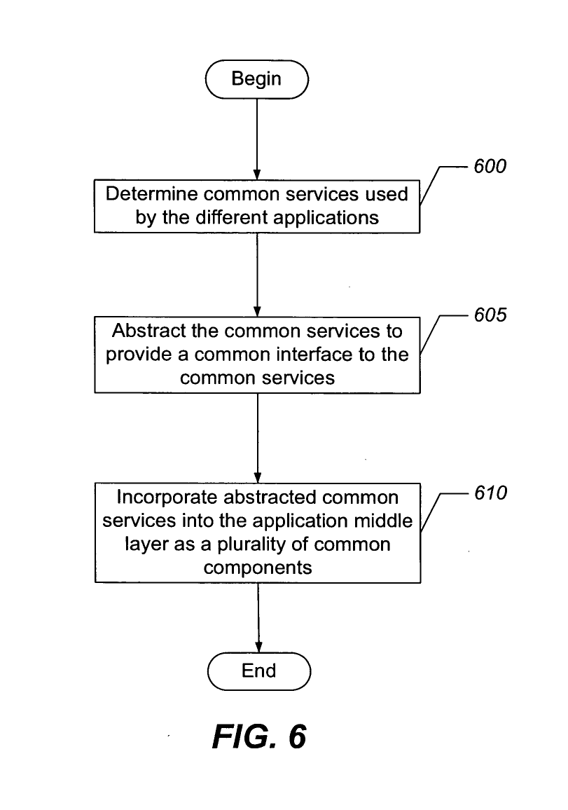

Referring now to FIG. 6, operations for determining what services are provided by the components comprising the eSDP middle layer, in accordance with some embodiments of the present invention, begin at block 600 where the common services that are used by IMS/SIP applications, Web/SDP applications, and/or converged Web-IMS/SIP applications are determined. These common services are abstracted at block 605 so as to provide a common interface to the common services that may be shared among the various applications. At block 610, these abstracted common services are incorporated into the eSDP application middle layer as a plurality of common components and sub-components.

In accordance with various embodiments of the present invention, at least one of the eSDP components provides a service/function/capability to at least one IMS/SIP, Web/SDP, and/or converged Web-IMS/SIP application in support of the application's interaction with one or more end users. The IMS/SIP, Web/SDP, and/or converged Web-IMS/SIP applications may comprise both third party applications and/or network service provider applications.

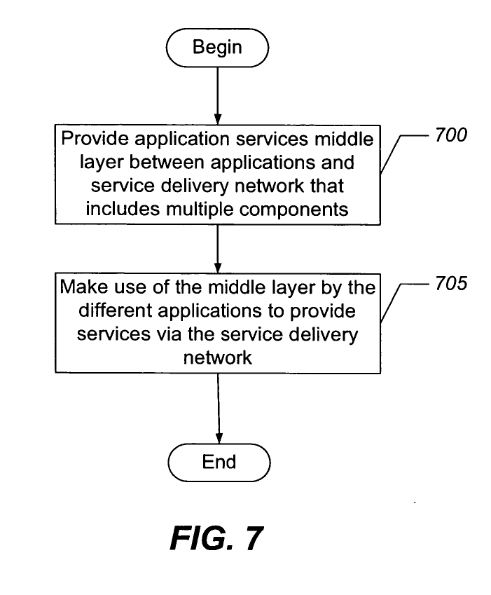

Referring now to FIG. 7, operations for delivering services over a service delivery network, in accordance with some embodiments of the present invention, begin at block 700 where an eSDP application services middle layer that includes multiple components is provided between applications, such as IMS/SIP, Web/SDP, and/or converged Web-IMS/SIP applications, and the service delivery network. At block 705, the different applications and users/subscribers may make use of the eSDP middle layer to provide services via the service delivery network.

The flowcharts of FIGS. 6 and 7 illustrate the architecture, functionality, and operations of embodiments of methods, systems, and/or computer program products for operating a service delivery system/network. In this regard, each block represents a module, segment, or portion of code, which comprises one or more executable instructions for implementing the specified logical function(s). It should also be noted that in other implementations, the function(s) noted in the blocks may occur out of the order noted in FIGS. 6 and 7. For example, two blocks shown in succession may, in fact, be executed substantially concurrently or the blocks may sometimes be executed in the reverse order, depending on the functionality involved.

Advantageously, as discussed above, eSDP may provide a cohesive architecture for the creation, deployment, delivery, and/or customization of services that is independent of the type of service protocol, network, and/or underlying network access technology that is used. This may allow a network operator and/or application service provider to test and launch new products and features faster at a lower cost per service because of common functionality that can be shared across applications may be integrated into the eSDP components. Moreover, both stand-alone applications and converged applications, i.e., applications that use multiple types of services, such as IMS/SIP services and Web services, may be supported.

Many variations and modifications can be made to the embodiments without substantially departing from the principles of the present invention. All such variations and modifications are intended to be included herein within the scope of the present invention, as set forth in the following claims.

That which is claimed:

1. A system for supporting Internet protocol (IP) multimedia subsystem (IMS) applications, Web based applications, and converged IMS/Web based applications that use a service delivery network, comprising:
an application services middle layer between the applications and the service delivery network that comprises a plurality of common components that are usable by the different applications to provide services over the service delivery network.

2. The system of claim 1, wherein the different applications comprise both third party applications and network service provider applications.

3. The system of claim 1, wherein at least one of the common components provides a service to at least one application in support of the application's interaction with one or more end users.

4. The system of claim 1, wherein the plurality of common components comprises a unified directory component that is configured to store and manage an applications services middle layer information model.

5. The system of claim 1, wherein the unified directory component comprises:
an identity management sub-component that is configured to support the creation and management of digital identities used for user authentication and assignment of rights and privileges to individuals within a subscription;
a profile management sub-component that is configured to allow access to and manage common user data within the information model;
a subscription management sub-component that is configured to provide access to and to manage subscriber information within the information model;
a services support sub-component that is configured to manage and provide access to information about service providers, service features, service availability, and/or service metadata;
a security support sub-component that is configured to create and maintain user and device authentication, integrity, and/or ciphering data;
a session management support sub-component that is configured to support call and/or session establishment procedures; and
a policy support sub-component that is configured to provide rules governing the user and delivery of the services.

6. The system of claim 1, wherein the plurality of common components comprises a content services component that is configured to control content acquisition and delivery of the content to subscribers of content services.

7. The system of claim 6, wherein the content services component comprises:
a content management sub-component that is configured to manage the life cycle of content objects; and
a digital rights management sub-component that is configured to control consumption of digital media objects by allowing content providers to express usage rights.

8. The system of claim 1, wherein the plurality of common components comprises a session management component that is configured to manage the orchestration, interaction, and delivery of the services during a subscribed session.

9. The system of claim 8, wherein the session management component comprises:
a converged services management sub-component that is configured to manage an integration session context comprising a plurality of service types;
a mobility management sub-component that is configured to enable roaming for an end user by providing hand-off of applications that are in progress; and
a service policy management component that is configured to determine service characteristics based on defined rules.

10. The system of claim 1, wherein the plurality of common components comprises a location services component that is configured to aggregate information about a physical/geographic location of a user, device, network, and/or network entity.

11. The system of claim 1, wherein the plurality of common components comprises a notification services component that is configured to send notices to users and/or devices on demand, at a defined time, and/or on a scheduled basis.

12. The system of claim 1, wherein the plurality of common components comprises a presence services component that is configured to aggregate user and/or device availability information across applications, devices, and/or networks.

13. The system of claim 1, wherein the plurality of common components comprises a security component that is configured to manage security associated with delivery of the services.

14. The system of claim 1, wherein the security component comprises:
an authentication/authorization sub-component that is configured to authenticate users and to authorize the users to invoke the applications and/or the services;
a single sign on sub-component that is configured to enable users to be authenticated across multiple services and/or applications; and
a security policy management sub-component that is configured to manage policies and/or rules associated with user and/or device authentication and/or authorization.

15. The system of claim 1, wherein the plurality of common components comprises a service creation component that is configured to support the definition, creation, and/or registering of the services.

16. The system of claim 15, wherein the service creation component comprises a service definition/packaging sub-component that is configured to define and/or package the services for presentation and consumption.

17. The system of claim 1, wherein the plurality of common components comprises a service provisioning component that is configured to create an instance of a registered service for a particular subscriber.

18. The system of claim 17, wherein the service provisioning component comprises a provisioning request management sub-component that is configured to create a service instance based on a service catalog.

19. The system of claim 1, wherein the plurality of common components comprises a performance management component that is configured to ensure that the services are delivered according to a particular quality of service (QoS).

20. The system of claim 19, wherein the performance management component comprises:
a QoS event collection sub-component that is configured to detect and collect information on QoS violations; and
a resource management sub-component that is configured to manage resources used to deliver the services.

21. The system of claim 1, wherein the plurality of common components comprises a partner management component that is configured to manage the access of third parties to the applications, services, and/or common components.

22. The system of claim 21, wherein the partner management component comprises:
a partner services sub-component that is configured to control and/or audit access to the applications, services, and/or common components; and
a third party interface sub-component that is configured to provide binding of third party applications to the applications and/or common components.

23. The system of claim 1, wherein the plurality of common components comprises a usage data collection component that is configured to collect and aggregate information on usage of the services.

24. The system of claim 23, wherein the usage data collection component comprises a usage/events collection sub-component that is configured to capture user and/or network events.

25. The system of claim 1, wherein the plurality of common components comprises a gateways component that is configured to provide access to services on other networks and/or to subscriber devices.

26. The system of claim 25, wherein the gateways component comprises:
a circuit switched access sub-component that is configured to provide connectivity to public switched telephone network (PSTN) services;
an advanced intelligent network (AIN) access sub-component that is configured to provide connectivity to PSTN signaling system seven (SS7) services; and
a devices services sub-component that is configured to allow the subscriber devices to access the applications and/or services.

27. A computer program product comprising a computer readable medium having computer readable program code embodied therein, the computer readable program code comprising computer readable program code configured to provide the application services middle layer recited in claim 1.

28. A method of providing services for an application middle layer between Internet protocol (IP) multimedia subsystem (IMS) applications, Web based applications, and converged IMS/Web based applications and a service delivery network, comprising:
determining common services used by the different applications;
abstracting the common services to provide a common interface to the services to the different applications; and
incorporating the abstracted common services into the application middle layer as a plurality of common components.

29. The method of claim 28, wherein the different applications comprise both third party applications and network service provider applications.

30. A method of delivering services over a service delivery network, comprising:
providing an application services middle layer between Internet protocol (IP) multimedia subsystem (IMS) applications, Web based applications, and converged IMS/Web based applications and the service delivery network that comprises a plurality of common components; and
making use of the plurality of common components by the different applications to provide services via the service delivery network.

31. The method of claim 30, wherein the different applications comprise both third party applications and network service provider applications.
